(19) United States
(12) Patent Application Publication
(10) Pub. No.: US 2025/0303976 A1
(43) Pub. Date: Oct. 2, 2025

(54) MOTOR VEHICLE ACCESSORY RECEIVER BRACKET ASSEMBLIES

(71) Applicant: FORD GLOBAL TECHNOLOGIES, LLC, Dearborn, MI (US)

(72) Inventor: Joseph PRIOR, Detroit, MI (US)

(21) Appl. No.: 18/623,169

(22) Filed: Apr. 1, 2024

(51) Int. Cl. B60R 11/00

(52) U.S. Cl. CPC B60R 11/00; B60R 2011/0063

(57) ABSTRACT

Exemplary accessory receiver bracket assemblies for mounting a wide range of accessories to a motor vehicle during stationary or non-moving conditions of the vehicle. Each accessory receiver bracket assembly may provide generic and secure attachment points for securing an accessory relative to the vehicle. An exemplary accessory receiver bracket assembly may be mounted to a hinge assembly of a vehicle closure member system and may include a first receiver bracket section, a second receiver bracket section, and one of more mechanical fasteners for securing the first and second receiver bracket sections together to at least partially surround the hinge assembly.

### TECHNICAL FIELD

This disclosure relates generally to motor vehicles, and more particularly to accessory receiver bracket assemblies for mounting a wide variety of accessories relative to the vehicle while the vehicle is stationary.

### BACKGROUND

Motor vehicles typically include one or more closure members. Exemplary closure members are doors and swing gates. Generally, closure members can be moved between open and closed positions relative to a body structure of the vehicle in order to provide vehicle ingress/egress.

### SUMMARY

A vehicle closure member system according to an exemplary aspect of the present disclosure includes, among other things, a hinge assembly, and an accessory receiver bracket assembly positioned to at least partially surround the hinge assembly. The accessory receiver bracket assembly includes a first receiver bracket section, a second receiver bracket section, and a fastener that secures the first receiver bracket section and the second receiver bracket section together.

In a further non-limiting embodiment of the foregoing vehicle closure member system, the first receiver bracket section is arranged at an upper section of the hinge assembly, and the second receiver bracket section is arranged at a lower section of the hinge assembly.

In a further non-limiting embodiment of either of the foregoing vehicle closure member systems, the upper section and the lower section are part of a hinge bracket of the hinge assembly.

In a further non-limiting embodiment of any of the foregoing vehicle closure member systems, the hinge bracket is mounted to a swing gate of the vehicle closure member system.

In a further non-limiting embodiment of any of the foregoing vehicle closure member systems, the first receiver bracket section and the second receiver bracket section each include a body portion and a hook portion.

In a further non-limiting embodiment of any of the foregoing vehicle closure member systems, the hook portion is configured to hook onto a hinge bracket of the hinge assembly.

In a further non-limiting embodiment of any of the foregoing vehicle closure member systems, a first hook section of the hook portion is configured to interface with an exterior surface of the hinge bracket, a second hook section of the hook portion is configured to interface with an interior surface of the hinge bracket, and a bridge section of the hook portion is configured to interface with an upper horizontal surface of the hinge bracket.

In a further non-limiting embodiment of any of the foregoing vehicle closure member systems, a portion of each of the first hook section, the second hook section, and the bridge section includes a protective lining.

In a further non-limiting embodiment of any of the foregoing vehicle closure member systems, the hook portion is received within a recess of an interior surface of the hinge bracket.

In a further non-limiting embodiment of any of the foregoing vehicle closure member systems, the recess extends between a first mounting pad and a second mounting pad of the interior surface of the hinge bracket.

In a further non-limiting embodiment of any of the foregoing vehicle closure member systems, the body portion includes at least one tapped opening.

In a further non-limiting embodiment of any of the foregoing vehicle closure member systems, the body portion includes at least one locating opening that is sized to receive a locating post of the first receiver bracket section, the second receiver bracket section, or an accessory.

In a further non-limiting embodiment of any of the foregoing vehicle closure member systems, the fastener extends through a clearance opening of the second receiver bracket section and into a tapped opening of the first receiver bracket section.

A vehicle closure member system according to another exemplary aspect of the present disclosure includes, among other things, a closure member, a first hinge assembly mounted to the closure member, a first accessory receiver bracket assembly removably mountable to the first hinge assembly, and an accessory mounted to the first accessory receiver bracket assembly.

In a further non-limiting embodiment of the foregoing vehicle closure member system, the closure member is a rear swing gate.

In a further non-limiting embodiment of either of the foregoing vehicle closure member systems, the first hinge assembly includes a body-side hinge bracket mounted to a vehicle body and a door-side hinge bracket mounted to the closure member.

In a further non-limiting embodiment of any of the foregoing vehicle closure member systems, the first accessory receiver bracket assembly is configured to hook onto the door-side hinge bracket.

In a further non-limiting embodiment of any of the foregoing vehicle closure member systems, a second hinge assembly is mounted to the closure member, and a second accessory receiver bracket assembly removably mountable to the second hinge assembly. The accessory is mounted to each of the first accessory receiver bracket assembly and the second accessory receiver bracket assembly.

In a further non-limiting embodiment of any of the foregoing vehicle closure member systems, the accessory is a television mounting system.

In a further non-limiting embodiment of any of the foregoing vehicle closure member systems, the accessory is a modular lightweight load-carrying equipment (MOLLE) panel.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 illustrates a motor vehicle equipped with a closure member system. The closure member system is shown in a closed position in FIG. 1.

FIG. 2 illustrates an open position of the closure member system of FIG. 1.

FIG. 3 illustrates select portions of a vehicle closure member system. One or more accessory receiver bracket assemblies can be removably mounted to each hinge assembly of the vehicle closure member system.

FIG. 4 illustrates an exemplary accessory receiver bracket assembly for use with a vehicle closure member system.

FIG. 5 is an exploded view of the accessory receiver bracket assembly of FIG. 4.

FIG. 6 is a cross-sectional view through section 6-6 of FIG. 4.

FIG. 7 is a rear view of select portions of a vehicle closure member system.

FIG. 8 is a front exploded view of an accessory receiver bracket assembly.

FIG. 9 is a rear exploded view of an accessory receiver bracket assembly.

FIGS. 10A and 10B illustrate an exemplary accessory that can be mounted relative to a vehicle closure member by a pair of accessory receiver bracket assemblies.

FIGS. 11A, 11B, 11C, 11D, and 11E illustrate another exemplary accessory that can be mounted relative to a vehicle closure member by a pair of accessory receiver bracket assemblies.

### DETAILED DESCRIPTION

This disclosure details exemplary accessory receiver bracket assemblies for mounting a wide range of accessories to a motor vehicle during stationary or non-moving conditions of the vehicle. Each accessory receiver bracket assembly may provide generic and secure attachment points for securing an accessory relative to the vehicle. An exemplary accessory receiver bracket assembly may be mounted to a hinge assembly of a vehicle closure member system and may include a first receiver bracket section, a second receiver bracket section, and one of more mechanical fasteners for securing the first and second receiver bracket sections together to at least partially surround the hinge assembly. These and other features of this disclosure are described in greater detail below.

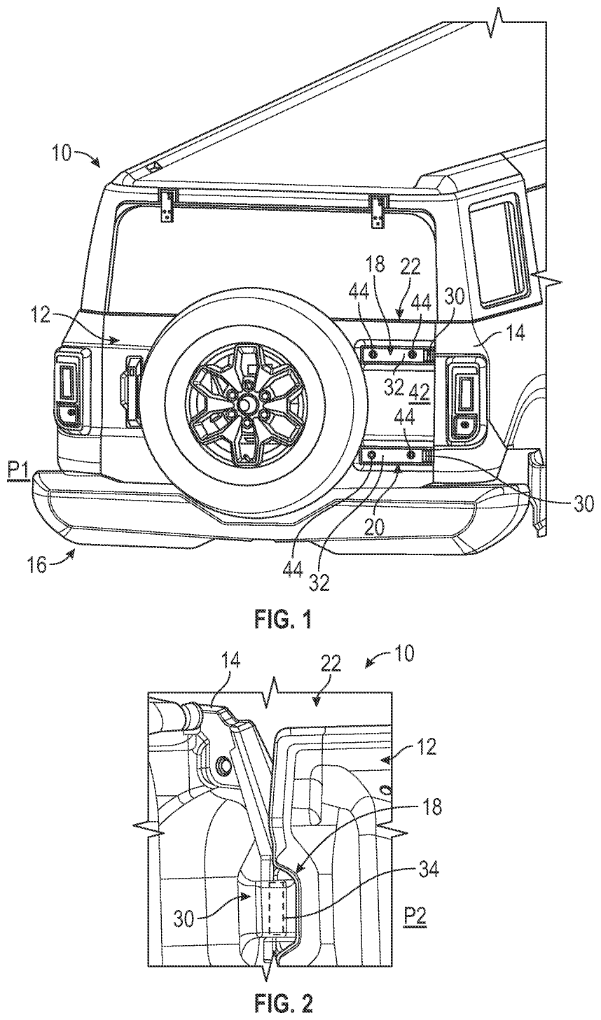

FIGS. 1 and 2 schematically illustrate select portions of a motor vehicle 10 (hereinafter referred to simply as “vehicle”). The vehicle 10 may be a car, a truck, a van, a sport utility vehicle, a semi tractor-trailer, or any other type of vehicle. The vehicle 10 could also be a conventional motor vehicle, a traction battery powered hybrid or electric vehicle, or an autonomous vehicle (i.e., a driverless vehicle).

Although a specific component relationship is illustrated in the figures of this disclosure, the illustrations are not intended to limit this disclosure. In other words, the placement and orientation of the various components of the vehicle 10 are shown schematically and could vary within the scope of this disclosure. In addition, the various figures accompanying this disclosure are not necessarily drawn to scale, and some features may be exaggerated or minimized to emphasize certain details of a particular component, assembly, or system.

The vehicle 10 may include one or more closure members 12 that are mounted relative to a vehicle body 14 and configured to move between closed and open positions for accessing a vehicle interior (e.g., a cargo space, a passenger cabin, etc.). In the illustrated embodiment, the closure member 12 is mounted at a rear 16 of the vehicle 10 and is configured as a swing gate. In other implementations, the closure member 12 could be part of a dual out-swinging door system that may be provided at the rear 16 of the vehicle 10 for gaining access to the vehicle interior, such as for loading and/or unloading cargo, for example. However, the teachings of this disclosure are not limited to swing gates and rear out-swinging type doors and could apply to various other types of closure members, including but not limited to side doors, tailgates, etc.

The closure member 12 may be movably mounted to the vehicle body 14 by a first hinge assembly 18 and a second hinge assembly 20. The first and second hinge assemblies 18, 20 may movably support the closure member 12 relative to the vehicle body 14. Together, the closure member 12, the first hinge assembly 18, and the second hinge assembly 20 may establish a closure member system 22 of the vehicle 10. Although two hinge assemblies are illustrated in the exemplary embodiment, the closure member system 22 could include a greater or fewer number of hinge assemblies.

The first hinge assembly 18 may be mounted at a location of the closure member 12 that is vertically above the second hinge assembly 20. However, other configurations could be possible within the scope of this disclosure. Vertical and horizontal, for purposes of this disclosure, are with reference to ground in an ordinary orientation of the vehicle 10 during operation.

In an embodiment, the first hinge assembly 18 and the second hinge assembly 20 are visible when the closure member 12 is closed. The first and second hinge assemblies 18, 20 may therefore be considered exposed or “Class A” type hinge assemblies.

The design of the second hinge assembly 20 may be substantially identical to that of the first hinge assembly 18. Therefore, for the purposes of this disclosure, details described herein related to the first hinge assembly 18 should be understood to apply equally to the second hinge assembly 20 unless otherwise indicated.

The closure member 12 is shown in a closed position P1 in FIG. 1 and in an open position P2 in FIG. 2. When moved to the open position P2, the closure member 12 permits users to access the vehicle interior. When closed, the closure member 12 provides a barrier between the interior and the exterior of the vehicle 10. Although not specifically shown, the closure member 12 may be moved to various angular positions between the closed position P1 and the open position P2.

In an embodiment, the closure member 12 is angularly displaced relative to the vehicle body 14 by about 100° or more when moved to the open position P2 of FIG. 2. In this disclosure, the term “about” means that the expressed quantities or ranges need not be exact but may be approximated and/or larger or smaller, reflecting acceptable tolerances, conversion factors, measurement error, etc. A total range of motion of the closure member 12 may vary and is dependent on various design criteria.

A vehicle user may periodically desire to utilize the vehicle 10 as a social gathering spot during outdoor activities (e.g., camping, tailgating, etc.). As part of supporting these activities, the user may desire to mount one or more accessories to the vehicle 10. Some users may find it difficult to mount accessories to the vehicle 10 without first removing a vehicle component or drilling directly into the vehicle body 14. This disclosure is therefore directed to accessory receiver bracket assemblies that can be utilized in combination with the closure member system 22 for securing a wide range of accessories relative to the vehicle 10 while the vehicle 10 is stationary or non-moving.

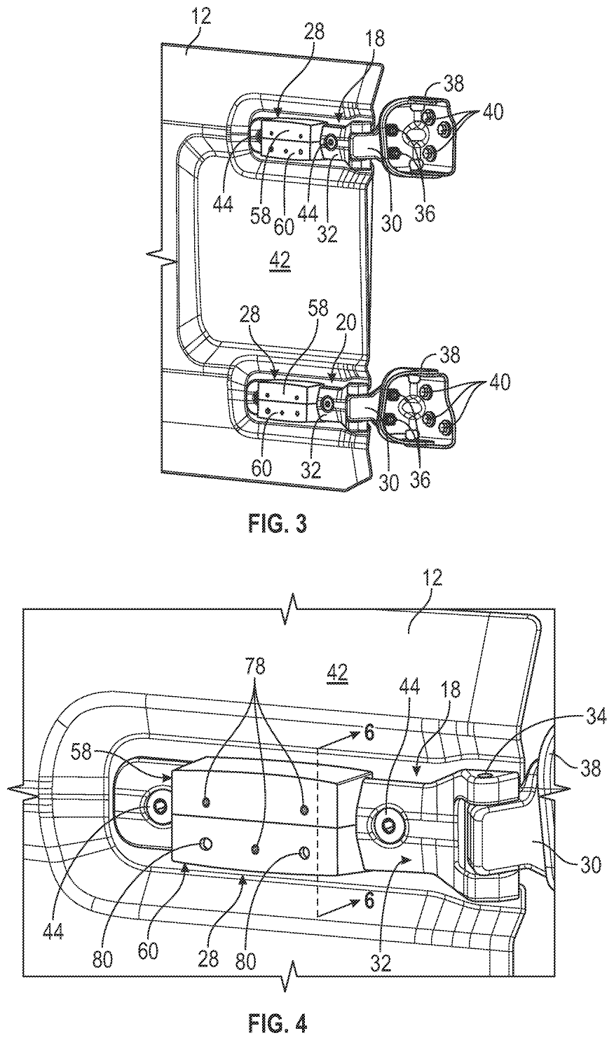

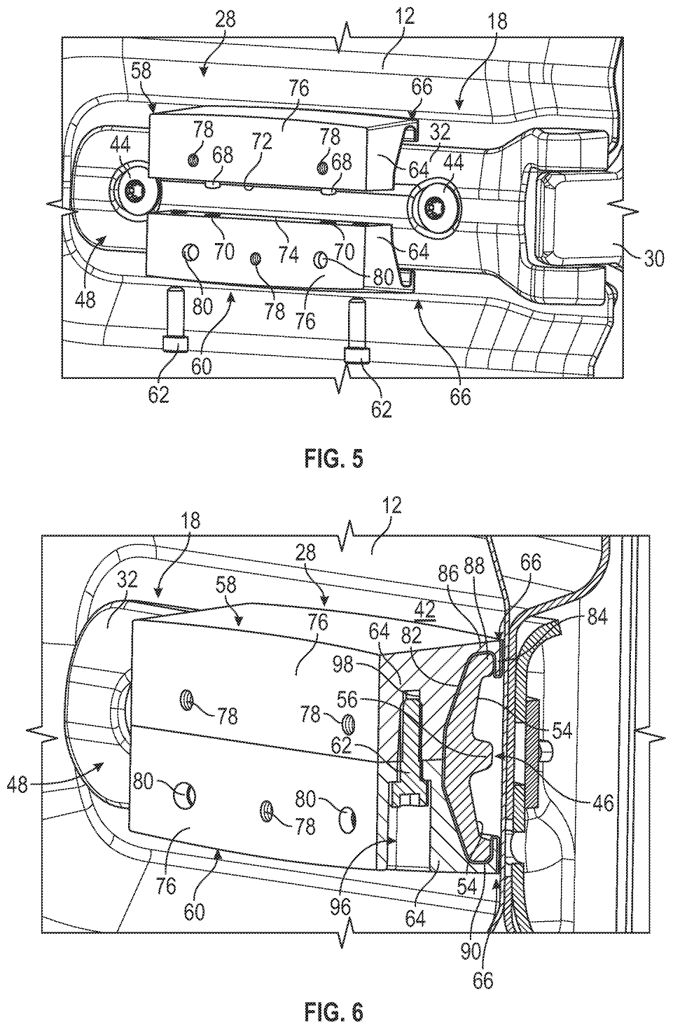

FIGS. 3, 4, 5, 6, 7, 8, and 9, with continued reference to FIGS. 1 and 2, illustrate details associated with an accessory receiver bracket assembly 28 that can be removably mounted to the closure member system 22 for facilitating the ability to mount one or more accessories relative to the vehicle 10 while the vehicle 10 is in a stationary, non-moving condition. Although two accessory receiver bracket assemblies 28 are shown in the exemplary figures (e.g., one on each of the first hinge assembly 18 and the second hinge assembly 20), it should be understood that one or more accessory receiver bracket assemblies 28 could be mounted to the closure member system 22 for securing accessories relative to the vehicle 10.

Each accessory receiver bracket assembly 28 may be configured to engage either the first hinge assembly 18 or the second hinge assembly 20 in order to mount the accessory receiver bracket assembly 28 to the closure member system 22. The first hinge assembly 18 and the second hinge assembly 20 of the closure member system 22 may each include a body-side hinge bracket 30 and a door-side hinge bracket 32. The door-side hinge bracket 32 may be pivotably connected to the body-side hinge bracket 30 by a pivot pin 34 (see, e.g., FIGS. 2 and 4).

The body-side hinge bracket 30 may be mounted relative to the vehicle body 14 by one or more mechanical fasteners 36 (see FIG. 3). In an embodiment, the mechanical fasteners 36 secure the body-side hinge bracket 30 to a hinge attach bracket 38. The hinge attach bracket 38 may be secured to another component of the vehicle body 14 by one or more additional mechanical fasteners 40 (see FIG. 3) for securing the body-side hinge bracket 30 relative to the vehicle body 14.

The door-side hinge bracket 32 may be mounted to an exterior surface 42 of the closure member 12 by one or more mechanical fasteners 44. The exterior surface 42 may be referred to as the “class A-surface” of the closure member 12.

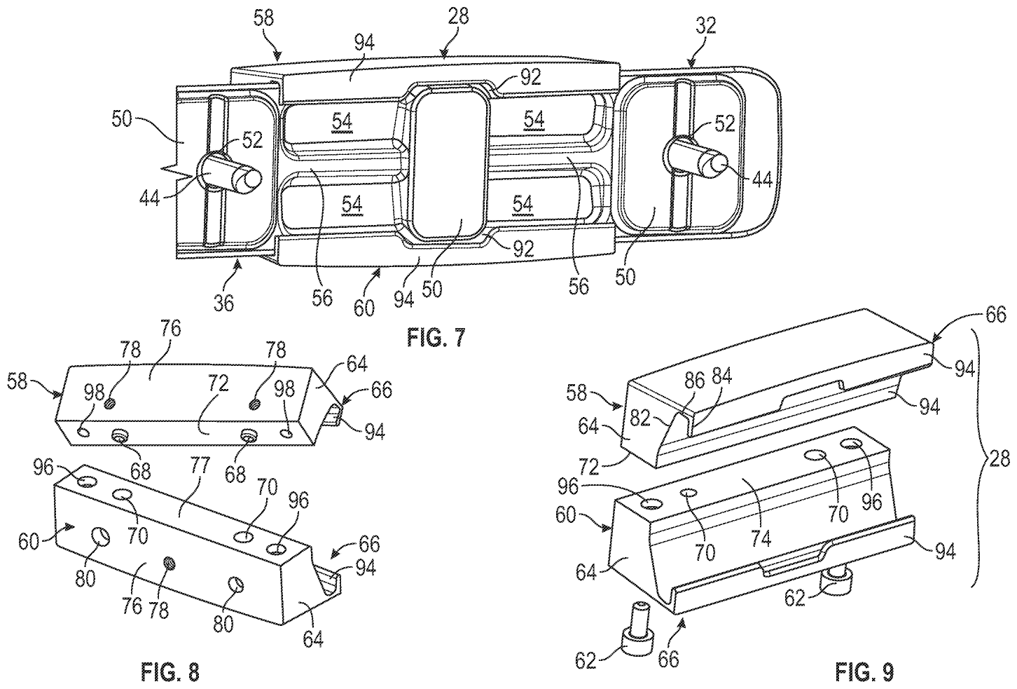

The door-side hinge bracket 32 may include an interior surface 46 (best shown in FIGS. 6-7) that faces in a direction toward the exterior surface 42 of the closure member 12 and an exterior surface 48 that faces in a direction away from the exterior surface 42 of the closure member 12 when mounted to the closure member 12. The interior surface 46 may include a plurality of mounting pads 50 that are designed to interface with the exterior surface 42 of the closure member 12. An opening 52 may be formed through at least a portion of the mounting pads 50. The openings 52 are sized to receive one of the mechanical fasteners 44 for mounting the door-side hinge bracket 32 to the closure member 12.

Recesses 54 may be formed in the interior surface 46 of the door-side hinge bracket 32. The recesses 54 may extend from the interior surface 46 in a direction toward the exterior surface 48 of the door-side hinge bracket 32. One or more of the recesses 54 can be disposed between adjacent pairs of the mounting pads 50. The recesses 54 create open spaces between the door-side hinge bracket 32 and the exterior surface 42 of the closure member 12 for allowing the accessory receiver bracket assembly 28 to hook or glove onto the door-side hinge bracket 32.

The interior surface 46 of the door-side hinge bracket 32 may additionally include one or more stiffening ribs 56 for increasing the strength and stiffness of the door-side hinge bracket 32. One or more of the stiffening ribs 56 can extend within each recess 54 between adjacent pairs of the mounting pads 50. However, the specific configuration of the stiffening ribs 56 is not intended to limit this disclosure.

The accessory receiver bracket assembly 28 may include an upper or first receiver bracket section 58, a lower or second receiver bracket section 60, and one or more mechanical fasteners 62 for securing the first and second receiver bracket sections 58, 60 together after the first and second receiver bracket sections 58, 60 have been arranged to a least partially surround the door-side hinge bracket 32. The first receiver bracket section 58 and the second receiver bracket section 60 may each include a body portion 64 and a hook portion 66. In an embodiment, the body portion 64 and the hook portion 66 are formed (e.g., cast) together to establish a single-piece integrated structure of the first and second receiver bracket sections 58, 60.

The body portion 64 of the first receiver bracket section 58 may include a pair of locating posts 68 that are configured to engage locating openings 70 of the body portion 64 of the second receiver bracket section 58 for ensuring that the first and second receiver bracket sections 58, 60 are properly aligned for receiving the fasteners 62. However, an opposite configuration is also contemplated within the scope of this disclosure in which the locating posts 68 are part of the body portion 64 of the second receiver bracket section 60 and the locating openings 70 are part of the body portion 64 of the first receiver bracket section 58. In an embodiment, one of the locating openings 70 is round to provide a 4-way locator and another of the locating openings 70 is oblong to provide a 2-way locator.

In an embodiment, the locating posts 68 protrude outwardly from a bottom surface 72 of the body portion 64 of the first receiver bracket section 58, and the locating openings 70 are formed in a top surface 74 of the body portion 64 of the second receiver bracket section 60. However, other configurations are contemplated within the scope of this disclosure.

A front surface 76 of the body portion 64 of each of the first receiver bracket section 58 and the second receiver bracket section 60 may include one or more tapped openings 78, one or more locating openings 80, or both. The front surfaces 76 may face in a direction away from the exterior surface 48 of the door-side hinge bracket 32 and are thus provided on an opposite side from the hook portions 66. The tapped openings 78 may be utilized for securing (e.g., bolting) accessories to the accessory receiver bracket assembly 28, and the locating openings 80 are configured to locate and thus properly align the accessories to the accessory receiver bracket assembly 28. In an embodiment, the first receiver bracket section 58 includes two tapped openings 78, and the second receiver bracket section 58 includes one tapped opening 78 and two locating openings 80. However, other configurations are contemplated within the scope of this disclosure.

Each hook portion 66 of the first and second receiver bracket sections 58, 60 is configured to engage the door-side hinge bracket 32 and may include a first hook section 82, a second hook section 84, and a bridge section 86 that connects between the first hook section 82 and the second hook section 84. When the accessory receiver bracket assembly 28 is secured to the door-side hinge bracket 32, the first hook section 82 may interface with the exterior surface 48, the second hook section 84 may interface with the interior surface 46, and the bridge section 86 may interface with either an upper horizontal surface 88 or a lower horizontal surface 90 of the door-side hinge bracket 32 (see FIG. 6).

The second hook sections 84 may be accommodated within the recesses 54 of the interior surface 46 to allow the hook portions 66 to hook or glove onto the door-side hinge bracket 32. The first and second receiver bracket sections 58, 60 therefore at least partially surround the door-side hinge bracket 32. The second hook sections 84 may include one or more cut-outs 92 for accommodating one or more of the mounting pads 50 of the door-side hinge bracket 32 (see FIG. 7).

A protective lining 94 may be provided on select portions of the hook portions 66 for protecting the respective surface finishes of the door-side hinge bracket 32 and the closure member 12 by eliminating metal-to-metal contact. The protective lining 94 may be provided on an inner surface of the first hook sections 82, an inner surface of the bridge sections 86, and both an inner surface and an outer surface of the second hook sections 84. In an embodiment, the protective lining 94 is a rubber (e.g., ethylene propylene diene monomer rubber) layer that is adhered to the hook portions 66. However, other configurations are contemplated within the scope of this disclosure.

When the first and second receiver bracket sections 58, 60 are gloved onto the door-side hinge bracket 32 and properly aligned relative to one another via the locating posts 68 and the locating openings 70, the first and second receiver bracket sections 58, 60 may be clamped together by the fasteners 62 to firmly secure the accessory receiver bracket assembly 28 to the door-side hinge bracket 32. Each fastener 62 may be a bolt, for example, and may be inserted through a clearance opening 96 formed in the second receiver bracket section 60 and into a tapped opening 98 formed in the first receiver bracket section 58.

The accessory receiver bracket assemblies 28 may each provide generic attachment points for securing a wide range of accessories to the vehicle 10. Exemplary accessories that could be secured to the vehicle 10 using one or more of the accessory receiver bracket assemblies 28 include but are not limited to bike racks, ski racks, snowboard racks, jerrycan mounting brackets, flag mounts, grille holders, off-road jack carriers, fishing pole holders or transport cases, swing-out tables, camping light posts, vehicle body removal hoists, modular lightweight load-carrying equipment (MOLLE) panels, articulating television mounting systems, etc. In some implementations, the accessories that are mounted by the accessory receiver bracket assemblies 28 are mounting accessories that themselves can be utilized to mount additional accessories to the vehicle 10 (e.g., skis, snowboards, bikes, fishing poles, televisions, tools, tables, trash bins, fire extinguishers, grills, shovels, supplies, etc.).

When not needed for mounting accessory items, each accessory receiver bracket assembly 28 can be disconnected from the door-side hinge bracket 32 of the first hinge assembly 18 or the second hinge assembly 20 and then stored within the vehicle 10. The accessory receiver bracket assemblies 28 can be stored at any suitable location inside the vehicle 10, including within any suitable storage bin of the passenger cabin or cargo area, for example.

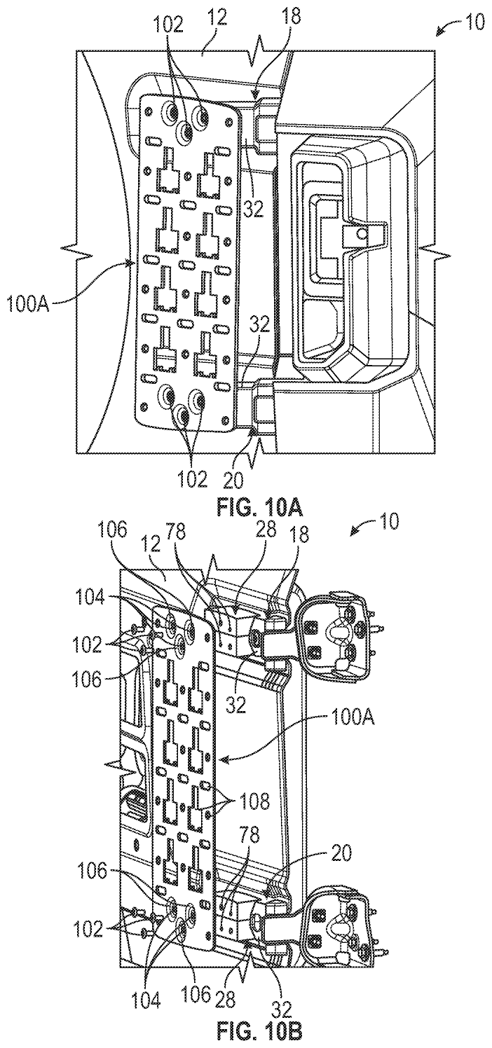

FIGS. 10A and 10B illustrate the use of a pair of accessory receiver bracket assemblies 28 for securing an accessory 100A to the closure member system 22 and thus to the vehicle 10. Although shown using two accessory receiver bracket assemblies 28, some accessories may require a greater or fewer number of accessory receiver bracket assemblies 28 in order to achieve mounting. In this implementation, the accessory 100A is a MOLLE panel that can be utilized to mount additional accessories (e.g., tie downs, hooks, tool holders, shelves, clips, straps, etc.) to the vehicle 10.

The accessory 100A may be mounted directly to the accessory receiver bracket assemblies 28 with a plurality of mechanical fasteners 102 (e.g., bolts, screws, etc.). Each fastener 102 may be inserted through a mounting opening 104 of the accessory 100A and then into one of the tapped openings 78 of the accessory receiver bracket assemblies 28 to mount the accessory 100A relative to the vehicle 10. In an embodiment, at least a portion of the mounting openings 104 may be configured as 2-way or 4-way locators. In another embodiment, the mounting openings 104 are located within depressions 106 of the accessory 100A.

The accessory 100A may additionally include an assortment of accessory compatible openings 108 for securing additional accessories to the accessory 100A. The accessory compatible openings 108 may be provided in various sizes and shapes. In an embodiment, a first portion of the accessory compatible openings 108 are configured as round openings, a second portion of the accessory compatible openings 108 are configured as slots, and a third portion of the accessory compatible openings 108 are configured as E-track accessory openings. However, other configurations are contemplated within the scope of this disclosure.

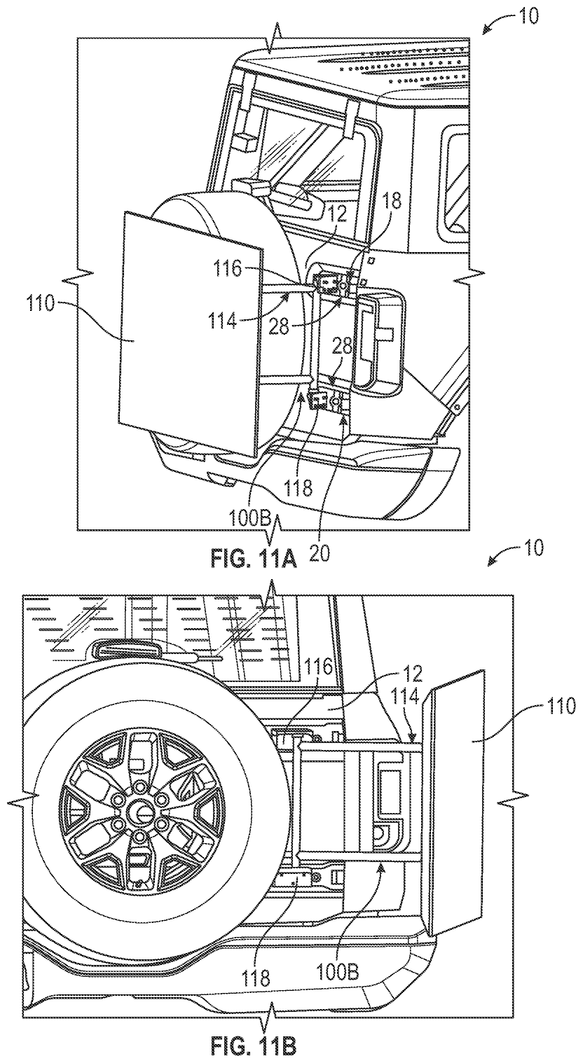

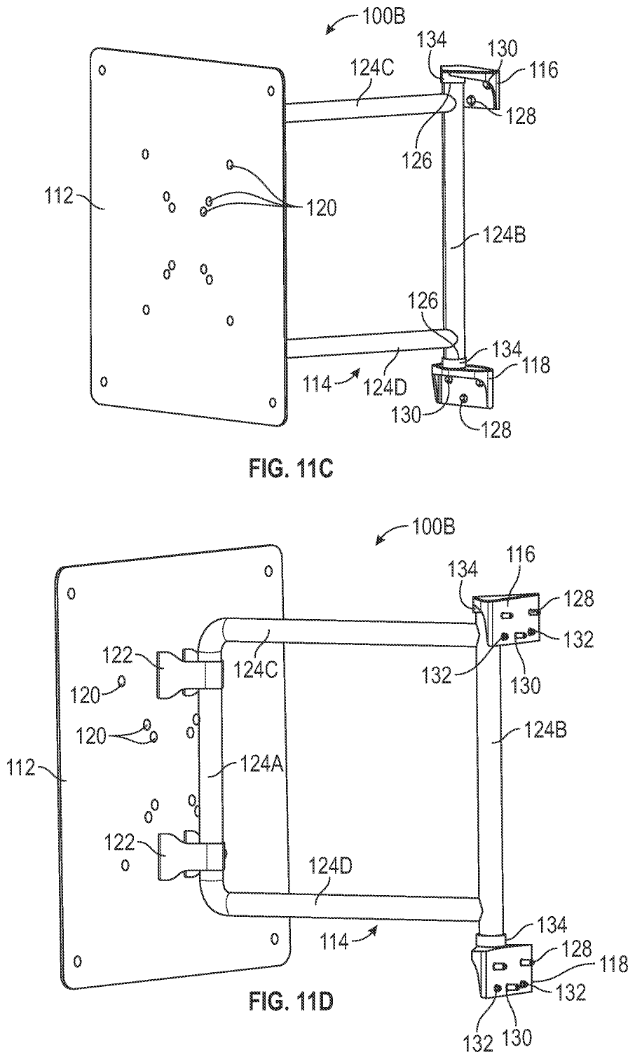

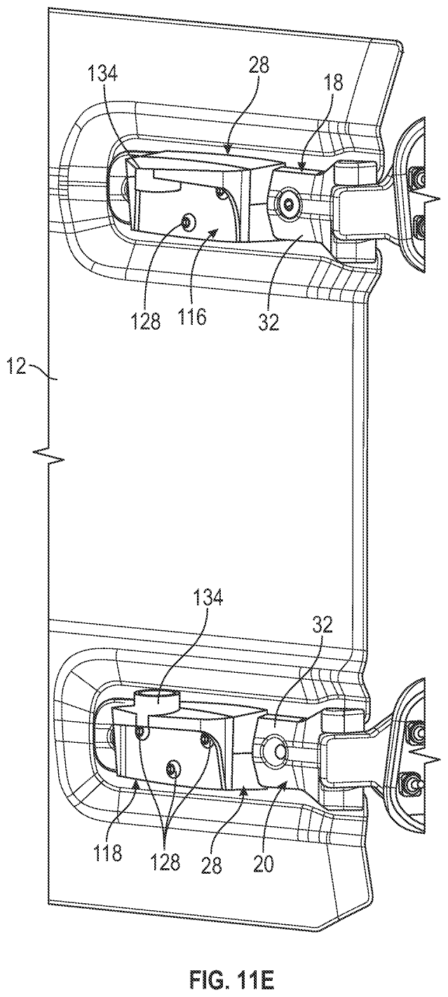

FIGS. 11A-11E illustrate the use of a pair of accessory receiver bracket assemblies 28 for securing another accessory 100B to the closure member system 22 and thus to the vehicle 10. In this implementation, the accessory 100B is a television (TV) mounting system for mounting a television (TV) 110 to the vehicle 10.

The accessory 100B may include a mounting plate 112, a tubular arm structure 114, a first bracket 116, and a second bracket 118. The mounting plate 112 may be a VESA compatible TV mounting plate and can thus accommodate various TV sizes and manufacturers. The mounting plate 112 may include a plurality of mounting openings 120 that can receive fasteners (not shown) for mounting the TV 110 to the mounting plate 112. The mounting plate 112 may additionally include one or more brackets 122 configured for connecting the tubular arm structure 114 to the mounting plate 112.

The tubular arm structure 114 may include a plurality of tubular arms 124A-124D. The tubular arms 124A-124D may be connected to one another, such as by welding, for example. The tubular arm 124A may be connected to the brackets 122 of the mounting plate 112 in either a rotatable or non-rotatable manner. The tubular arm 124B may be connected to the first bracket 116 and the second bracket 118 via bushings 126. The tubular arm 124B of the tubular arm structure 114 may therefore pivot relative to the first and second brackets 116, 118 at the bushings 126. Tubular arms 124C and 124D may connect between the tubular arm 124A and the tubular arm 124B.

The first bracket 116 may be mounted to the accessory receiver bracket assembly 28 that is secured to the first hinge assembly 18, and the second bracket 118 may be mounted to the accessory receiver bracket assembly 28 that is secured to the second hinge assembly 20 (see FIG. 11E). Mechanical fasteners 128 (e.g., bolts, screws, etc.) may be utilized to secure the first bracket 116 and the second bracket 118 to the accessory receiver bracket assemblies 28. The fasteners 128 may be inserted through mounting openings 130 of the first and second brackets 116, 118 and may be received within the tapped openings 78 of the accessory receiver bracket assemblies 28.

The first and second brackets 116, 118 may each include locating posts 132 (best shown in FIG. 11D) for locating the brackets relative to the accessory receiver bracket assemblies 28. The locating posts 132 are configured to engage the locating openings 80 of the accessory receiver bracket assemblies 28 for ensuring that the first and second brackets 116, 118 are properly aligned for receiving the fasteners 128 that are used to mount the first and second brackets 116, 118 to the accessory receiver bracket assemblies 28.

The first and second brackets 116, 118 may each include a cylindrical recess 134. Each cylindrical recess 134 is configured to receive one of the bushings 126 of the tubular arm structure 114, thereby allowing for rotation between the tubular arm structure 114 and the first and second brackets 116, 118 and thus rotation relative to the accessory receiver bracket assemblies 28. The TV 110 can therefore be pivoted between multiple angular positions relative to the closure member 12 when it is mounted to the accessory 100B and the accessory 100B is mounted to the accessory receiver bracket assemblies 28.

The accessory receiver bracket assemblies described herein facilitate a generic and secure attachment methodology for securing a wide range of accessories to a motor vehicle. The proposed accessory receiver bracket assemblies can connect to closure member hinge assemblies without requiring removal of any vehicle component and without the need to drill into the vehicle structure to create a secure fastener joint, thereby enabling fast and convenient usage.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A vehicle closure member system, comprising:
a hinge assembly;
an accessory receiver bracket assembly positioned to at least partially surround the hinge assembly; and
the accessory receiver bracket assembly including a first receiver bracket section, a second receiver bracket section, and a fastener that secures the first receiver bracket section and the second receiver bracket section together.

2. The vehicle closure member system as recited in claim 1, wherein the first receiver bracket section is arranged at an upper section of the hinge assembly, and the second receiver bracket section is arranged at a lower section of the hinge assembly.

3. The vehicle closure member system as recited in claim 2, wherein the upper section and the lower section are part of a hinge bracket of the hinge assembly.

4. The vehicle closure member system as recited in claim 3, wherein the hinge bracket is mounted to a swing gate of the vehicle closure member system.

5. The vehicle closure member system as recited in claim 1, wherein the first receiver bracket section and the second receiver bracket section each include a body portion and a hook portion.

6. The vehicle closure member system as recited in claim 5, wherein the hook portion is configured to hook onto a hinge bracket of the hinge assembly.

7. The vehicle closure member system as recited in claim 6, wherein a first hook section of the hook portion is configured to interface with an exterior surface of the hinge bracket, a second hook section of the hook portion is configured to interface with an interior surface of the hinge bracket, and a bridge section of the hook portion is configured to interface with an upper horizontal surface of the hinge bracket.

8. The vehicle closure member system as recited in claim 7, wherein a portion of each of the first hook section, the second hook section, and the bridge section includes a protective lining.

9. The vehicle closure member system as recited in claim 6, wherein the hook portion is received within a recess of an interior surface of the hinge bracket.

10. The vehicle closure member system as recited in claim 9, wherein the recess extends between a first mounting pad and a second mounting pad of the interior surface of the hinge bracket.

11. The vehicle closure member system as recited in claim 5, wherein the body portion includes at least one tapped opening.

12. The vehicle closure member system as recited in claim 5, wherein the body portion includes at least one locating opening that is sized to receive a locating post of the first receiver bracket section, the second receiver bracket section, or an accessory.

13. The vehicle closure member system as recited in claim 5, wherein the fastener extends through a clearance opening of the second receiver bracket section and into a tapped opening of the first receiver bracket section.

14. A vehicle closure member system, comprising:
a closure member;
a first hinge assembly mounted to the closure member;
a first accessory receiver bracket assembly removably mountable to the first hinge assembly; and
an accessory mounted to the first accessory receiver bracket assembly.

15. The vehicle closure member system as recited in claim 14, wherein the closure member is a rear swing gate.

16. The vehicle closure member system as recited in claim 14, wherein the first hinge assembly includes a body-side hinge bracket mounted to a vehicle body and a door-side hinge bracket mounted to the closure member.

17. The vehicle closure member system as recited in claim 16, wherein the first accessory receiver bracket assembly is configured to hook onto the door-side hinge bracket.

18. The vehicle closure member system as recited in claim 14, comprising a second hinge assembly mounted to the closure member, and a second accessory receiver bracket assembly removably mountable to the second hinge assembly, wherein the accessory is mounted to each of the first accessory receiver bracket assembly and the second accessory receiver bracket assembly.

19. The vehicle closure member system as recited in claim 14, wherein the accessory is a television mounting system.

20. The vehicle closure member system as recited in claim 14, wherein the accessory is a modular lightweight load-carrying equipment (MOLLE) panel.
